(19) United States
(12) Patent Application Publication
(10) Pub. No.: US 2006/0105868 A1
(43) Pub. Date: May 18, 2006

(54) Hydraulic control system for a continuously variable transmission mechanism

(76) Inventor: Steven P. Moorman, Dexter, MI (US)

Correspondence Address: LESLIE C. HODGES;General Motors Corporation, Legal Staff, Mail Code 482-C23-B21, P.O. Box 300, Detroit, MI, 48265-3000, US

(21) Appl. No.: 10/991,617

(22) Filed: Nov. 18, 2004

(51) Int. Cl. F16H 61/00; F16H 59/00

(52) U.S. Cl. 474/28; 474/18

(57) ABSTRACT

A hydraulic control system for a continuously variable transmission includes a source of fluid pressure provided by a pump and regulator valve. The fluid pressure of the pump is directed to a primary regulator valve, which issues a control pressure signal for a variable sheave control and a ratio enable valve, which directs the pressurized primary regulator valve to the variable pulley. The ratio enable valve is operable upon discontinuance of the primary regulator valve issuing a pressure signal and/or in response to a discontinuance of electronic control signal to establish a control pressure at the variable ratio pulley through a feed and bleed orifice system.

### TECHNICAL FIELD

This invention relates to hydraulic control systems for power transmissions and, more particularly, to hydraulic control systems for controlling the ratio system in a continuously variable transmission.

### BACKGROUND OF THE INVENTION

At least one type of continuously variable transmission (CVT) employs a flexible belt or chain and a pulley having at least one movable sheave on each pulley to establish ratio values between the input pulley and the output pulley. The output pulley or secondary pulley consists of a sliding sheave assembly, a return spring, a centrifugal compensator, and a piston. The system pressure acts on the piston, which clamps the sheaves of the secondary pulley together on the belt or chain.

The input or primary pulley consists of a sliding sheave assembly and a piston. The control pressure acts on the piston to squeeze the sheaves together to clamp the belt therebetween. Sufficient clamping force is required under all conditions of operation in order to prevent slippage between the belt and the sheaves. A small amount of belt slip can be detrimental to the transmission.

The transmission ratio is controlled by changing the force on the primary pulley thereby permitting the belt to change rotation on the pulley sheaves. Lowering the force on the piston of the primary pulley changes the ratio toward an underdrive condition, and raising the hydraulic force on the piston changes the ratio toward an overdrive condition.

The pressure on the primary piston or pulley is generally controlled by a ratio control valve which has an input signal recognizing either the position of the sheave as signal pressure or some other value which alternately feeds and exhausts the primary pressure port at the pulley piston until the desired ratio is established. Any hydraulic fluid exhausted from the piston area is returned to the transmission sump.

The controls for the prior art CVTs do not include, as a general rule, a limp-home capability in the event of a valve malfunction in the hydraulic control system. In conventional control practice, controlling the pressure within the primary pulley falls into two categories, indirect control and direct control.

There is an indirect control pressure where either pulley position or valve position are regulated to maintain a desired ratio. Since indirect controls do not directly control the pressure in the pulley system, it is difficult to ensure that enough pressure is provided for clamping during fast ratio changes and other abusive maneuvers.

The other pressure control system is a direct pressure control, which does directly control the pulley pressure. This control system allows good clamping control under all conditions. However, most direct pressure systems on the market today are susceptible to unacceptable modes wherein the primary pulley pressure very quickly falls to a low value such as when a stuck valve or inoperative modulating solenoid occurs. The result is a rapid movement in the transmission toward underdrive. This can lead to an engine overspeed, which is not desirable. Many of the current systems using direct pressure control do not account for all of the failure modes toward an underdrive condition. The present systems that do provide for underdrive failure control have hardware to provide this failure mode protection.

### SUMMARY OF THE INVENTION

It is an object of the present invention to provide an improved hydraulic control for a continuously variable transmission.

In one aspect of the present invention, a robust pressure control is provided for the continuously variable transmission.

In another aspect of the present invention, the control system provides for electrical and hydraulic discontinuances which result in a default ratio condition with a minimum amount of hardware.

In yet another aspect of the present invention, two control valves are provided including a primary regulator valve and a ratio-enabling valve.

In yet still another aspect of the present invention, the ratio-enabling valve is effective to provide sufficient control pressure to maintain a desired default ratio in the event of a primary regulator malfunction.

In a further aspect of the present invention, the ratio-enabling valve is effective to provide a proper control pressure to establish an default ratio in the event of an electronic solenoid malfunction.

In a still further aspect of the present invention, the primary regulator valve is operable to control the pressure value within the primary pulley under normal operating conditions.

### DESCRIPTION OF THE DRAWINGS

FIG. 1 is a schematic representation of a control system for use with a continuously variable transmission in the normal operating condition.

FIG. 2 is a view similar to FIG. 1 in which one of the valves is inoperative.

FIG. 3 is a view similar to FIG. 1 in which another of the valves is inoperative.

FIG. 4 is a view similar to FIG. 1 showing the primary blow-off valve in an alternate position.

FIG. 5 is a chart showing the pulley pressure versus control pressure for the control shown in FIG. 1.

FIG. 6 is a view similar to FIG. 5 showing the pressure relationship for the control system shown in FIG. 4.

FIG. 7 is a schematic representation of a powertrain incorporating the present invention.

### DESCRIPTION OF THE EXEMPLARY EMBODIMENT

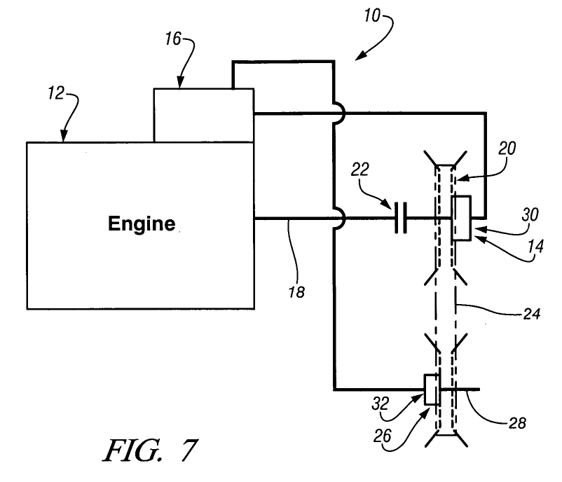

Referring to the drawings, wherein like characters represent the same or corresponding parts throughout the several views, there is seen in FIG. 7 a powertrain, generally designated 10, including an engine 12, a continuously variable transmission (CVT) 14, and an electronic control unit or module 16. The engine 12 has a drive shaft 18, which is operatively connectible with a primary pulley 20 of the CVT 14 through a selectively engageable clutch 22. The primary pulley 20 is drivingly connected through a flexible belt or chain 24 with a secondary sheave or pulley 26, which is drivingly connected with a transmission output shaft 28.

The primary pulley 20 has a control piston 30 and the secondary pulley 26 has a control piston 32. The control pistons 30 and 32 communicate with the control unit 16. The control system 16 issues commands or pressure signals in response to operating conditions, which establish the drive ratio between the primary and secondary pulleys 20 and 26. The ratio between the primary pulley 20 and the secondary pulley 26 establishes the drive ratio or speed ratio between the shaft 18 and the shaft 28.

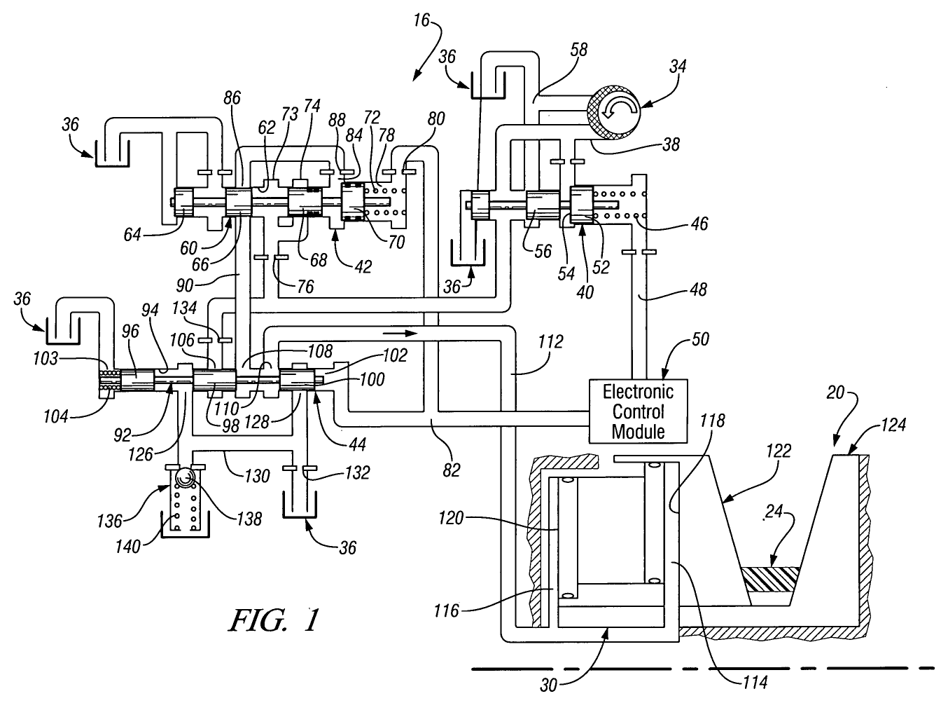

FIG. 1 describes a portion of the control system 16 and includes a hydraulic pump 34, which is driven by the engine 12. The hydraulic pump 34 draws fluid from a conventional reservoir or sump 36 and delivers hydraulic fluid through a line pressure passage 38. The line pressure passage 38 communicates through a system regulator valve 40 with a primary regulator valve 42 and a ratio enable valve 44.

The system regulator valve 40 establishes pressure in the passage 38 in response to the force in a bias spring 46 and a pressure in a control passage 48. The pressure in the control passage 48 is established by a conventional variable bleed solenoid valve, which is a portion of an electronic control module 16. As is well known, an electronic control module includes a preprogrammable digital computer, which is effective in response to various system signals to establish pressure levels. The preferred pressure control for the present system is a variable bleed type solenoid, which provides a control pressure in response to the opening and closing of a variable exhaust port. These types of pressure control mechanisms are well known.

The fluid pressure in passage 48 operates on a control land 52 of the valve 40 to establish a control signal, which is combated by or opposed by a pressure on a differential area 54 between the land 52 and a land 56. The valve 40 responds to the control biases and the pressure on the differential area 54 to establish a return of fluid through an exhaust passage 58, which exhausts excess fluid to the conventional sump 36 and the pump inlet for the pump 34. The pressure within the passage 38 is controlled within a range by the fluid pressure within the passage 48.

The primary regulator valve 42 includes a valve spool 60 that is slidably disposed in a valve bore 62. The valve spool 60 has three substantially equal diameter lands 64, 66, and 68, and a large diameter land 70. The valve 42 also includes a control or bias spring 72. The bias spring 72 urges the valve spool 60 leftward in the valve bore 62. The valve bore 62 is connected with a pair of inlet ports 73 and 74, which are in continuous fluid communication with the fluid in passage 38. The passage 38 is communicated with the ports 73 and 74 through an orifice or restriction 76.

The valve land 70 cooperates with the valve bore 62 to form a bias chamber 78, which is disposed in fluid communication through an orifice or restriction 80 in a passage 82. Passage 82 is a control pressure passage, which receives pressurized signals from the control 50. The valve bore 62 also includes a pair of primary feed ports 84 and 86. The primary feed ports 84 and 86 are in fluid communication through an orifice or restriction 88. The port 86 is in fluid communication with the ratio enable valve 44.

Fluid pressure from passage 82 in the chamber 78 acts in concert with the bias spring 72 to urge the valve spool 60 leftward, as seen in FIG. 1. The leftward movement of the valve spool 60 provides communication between the ports 86 and 73 thereby providing fluid communication between the passage 38 and a primary feed passage 90. The fluid in the primary feed passage 90 is reflected back through the orifice 88 and the port 84 to act on a differential area between the lands 68 and 70 to counteract the force of the pressure in the chamber 78 as well as the force in the bias spring 72.

When the fluid pressure in the passage 90 is sufficiently high, the bias pressure in passage 82 and the bias spring 72 will be balanced and the pressure in the primary feed passage 90 will be limited. If the control pressure in passage 82 is increased, the pressure in primary feed passage 90 will increase, and vice versa.

The ratio enable valve 44 includes a valve spool 92 slidably disposed in a valve bore 94. The valve spool 92 includes three equal diameter valve lands 96, 98, and 100. The valve land 100 cooperates with the bore 94 to form a control chamber 102, which is in fluid communication with the passage 82. The valve land 96 cooperates with the valve bore 94 to form a spring chamber 103 in which a spring 104 is located. The spring chamber 103 is connected through an exhaust passage with the transmission sump 36. The valve bore 94 is in communication through a port 106 with the main passage 38, through a port 108 with the passage 90, and through a port 110 with a pulley feed passage 112.

The pressure in the chamber 102 will urge leftward movement of the valve spool 92 against the spring 104 to provide fluid communication between the ports 108 and 110 such that the fluid pressure in passage 112 is equal to the fluid pressure in the passage 90. As discussed above, the fluid pressure in the passage 90 is controlled by the primary regulator valve 42 in response to the pressure signals issued by the electronic control 50.

The passage 112 communicates with a pair of control chambers 114 and 116, which are located on the primary pulley 20. These control chambers each have an effective piston area 118 and 120, which when pressurized will urge a movable sheave 122 of the pulley 20 toward the right to cause the belt or chain 24 to be moved outward between the movable sheave 122 and a stationary sheave 124. This, of course, will change the ratio of the CVT 14 from an underdrive condition toward and overdrive condition. The pressure in chambers 116 and 114 therefore control the ratio of the CVT 14.

The ratio enable valve 44 also has a pair of ports 126 and 128, which communicate through a passage 130. The passage 130 communicates through an orifice or restriction 132 with the transmission sump 36. When the ratio enable valve 44 is disposed in its rightmost condition, as established by the spring 104, the ports 106 and 126 are in fluid communication. The passage 130 is in fluid communication therefore with the passage 38 through an orifice or restriction 134.

The restrictions 134 and 132 form a feed-bleed system, which controls the pressure within the passage 130 and, since the ports 128 and 110 are in fluid communication between lands 98 and 100, the pressure in passage 112. Thus, the fluid pressure in the chambers 114 and 116 is controlled by the feed bleed orifices 134 and 132. These orifices are designed to provide sufficient pressure at the movable sheave 122 to establish the default ratio condition within the CVT 14 thereby providing the operator with sufficient drive conditions to return the vehicle to a repair location.

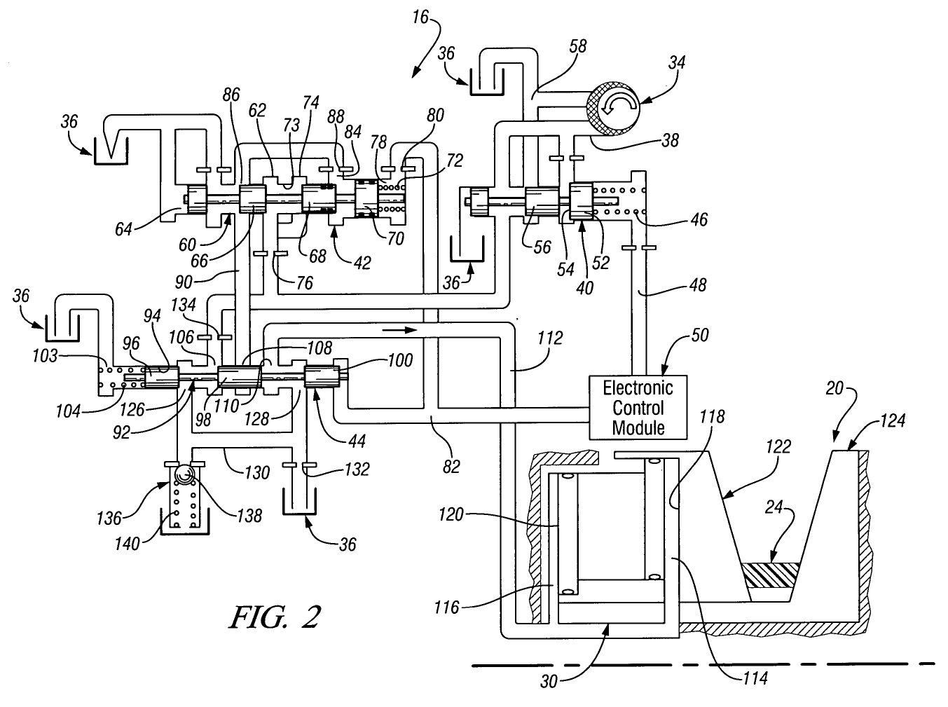

The condition shown in FIG. 2 occurs when the primary regulator valve 42 becomes stuck. The electronic control module 50 recognizes a stuck regulator valve by sensing an uncommanded movement in ratio toward underdrive. Thus, when the primary regulator valve 42 is stuck in an open condition such that the primary regulator feed passage pressure approaches zero, the electronic control module 50 will prevent or not issue a variable bleed solenoid pressure signal in passage 82.

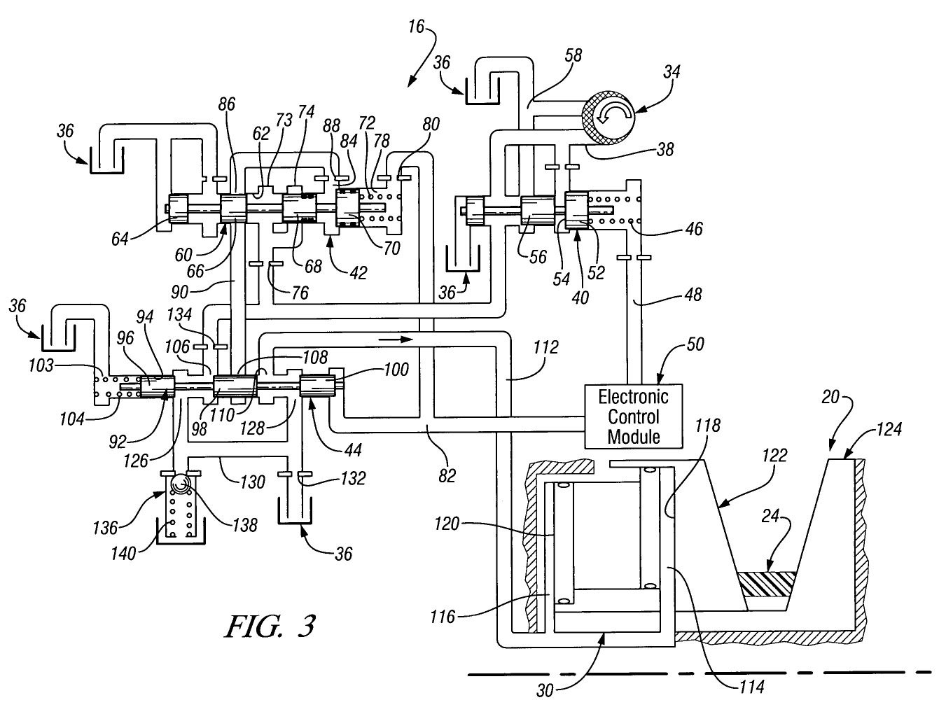

The control in FIG. 3 is shown in a condition similar to that shown in FIG. 2; however, in this condition, the system has lost the bleed control pressure in passage 82 due to a malfunction of either the electronic control module or the variable bleed solenoid in the electronic control module. Under this condition, the variable bleed signal in passage 82 is lost such that the pressure in passage 90 is established by the force in the bias spring 72 and this pressure may not be sufficient to provide the desired control function. Therefore, the ratio enable valve 44 is again shifted rightward by the spring 104 to cause the feed-bleed orifices 134 and 132 to be operative in establishing the pressure level in the passage 112 and the ratio within the CVT 14, as explained above. Thus, whenever a stuck regulator valve or a malfunctioning electronic control signal occurs, the CVT is established in a default ratio condition, which will be maintained until the system is repaired.

The control systems shown in FIGS. 1, 2, and 3 have a primary blow-off or a maximum system pressure valve 136, which is composed of a ball 138 and a control spring 140. These types of regulator or system control valves are well known. The valve 136 is effective to limit the pressure within the control system to a predetermined value in the event that either the regulator valve issues excess pressure or the pressure within the passage 112 becomes excessive.

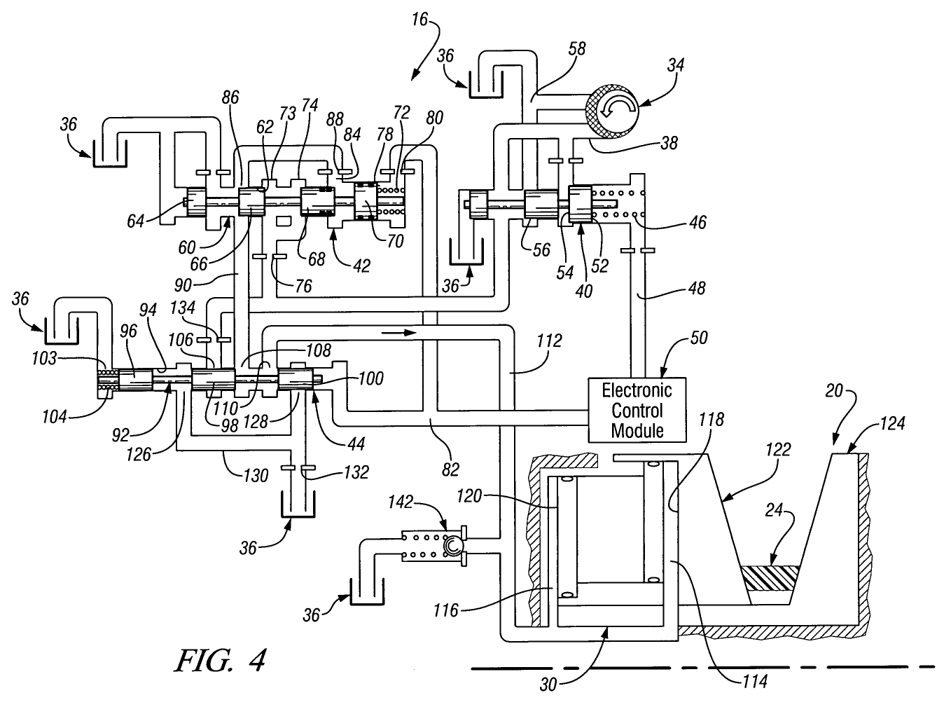

The control system shown in FIG. 4 is substantially identical with the control system shown in FIG. 1 with the exception that a primary blow-off valve 142 is placed directly in the passage 112. The primary blow-off valve or maximum system pressure valve 142 will provide the same function as the valve 136. Note that the valve 136, however, is placed between the feed and bleed orifices 134 and 132 such that the pressure in passage 130 is controlled as well as the pressure in passage 112. However, the system shown in FIG. 4 places the valve 142 downstream of the ratio enable valve 44 such that the pressure in passage 112 is controlled directly.

The positioning of the primary blow-off valve between the feed orifice 134 and bleed orifice 132 is of beneficial value in the design of the primary pulley. It is known that a stable hydraulic pressure is difficult to achieve when a regulator valve and a maximum system pressure blow-off 142 valve are each trying to regulate the circuit pressure in the same pressure range. If the system maximum pressure blow-off valve is placed at the primary pulley circuit downstream of the ratio enable valve 44, as shown in FIG. 4, the nominal blow-off pressure would need to be raised so that the lowest blow-off pressure, considering tolerances, is higher than the highest regulated primary feed pressure. The result is that the pulley pressure structural limits would need to be raised so that, a system wherein the maximum system pressure valve is controlling, the pulleys would not be damaged through the high pressure. This, of course, adds cost and mass to the transmission. The pulley pressure characteristics for such a system are shown in FIG. 6.

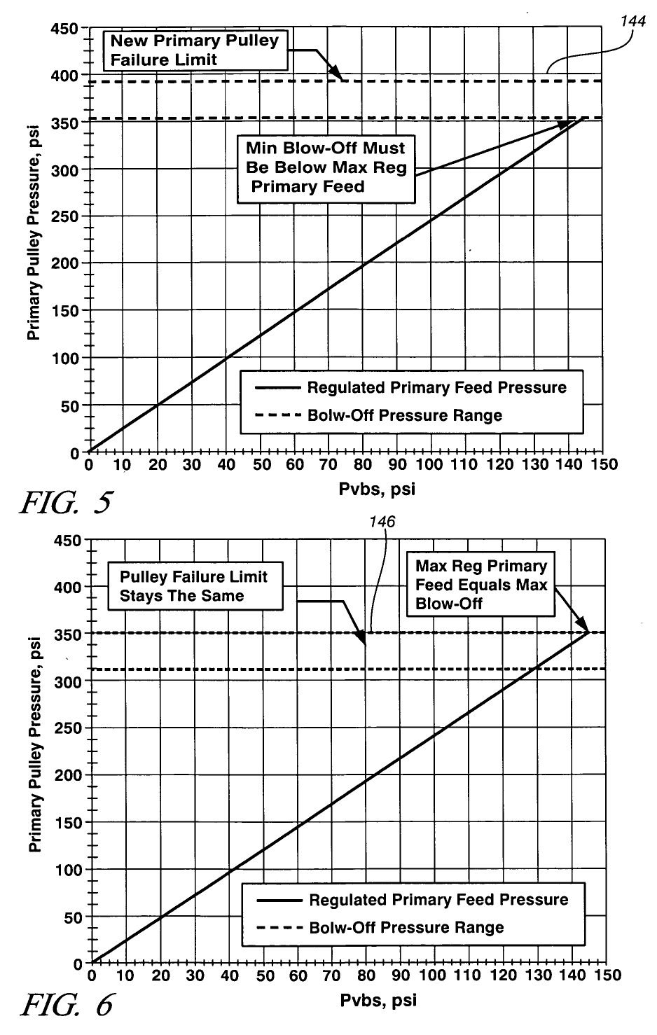

By positioning the primary blow-off valve between the feed orifice 134 and the bleed orifice 132, the ratio enable valve 44 ensures that the primary feed regulator valve 42 and the maximum system pressure blow-off valve 136 are never trying to regulate the pulley pressure at the same time. The result is that both the primary feed regulator valve 42 and the maximum system blow-off valve 136 have maximum pressures that can be set to the structural limit of the pulley. This allows the pulley design to remain unchanged. The pressure characteristics for this type of arrangement or valve situation are shown in FIG. 5.

It should be noted that in FIG. 5, the maximum primary pulley pressure is limited to a value.

As seen in FIG. 6, the pressure of the minimum value for the system blow-off pressure must be limited to a value below line 144 representing a pressure value, which is the structural limitation for the pulley. However, when the maximum primary blow-off pressure valve 136 is positioned in the passage 130, the maximum system pressure and the structural limit of the pulley are both at a pressure represented by line 146, as seen in FIG. 5. The pressure of line 146 is significantly lower than the pressure of line 144.

1. A hydraulic control system for a continuously variable transmission comprising:
a control piston;
a source of fluid pressure for delivering fluid at a system pressure;
an electronic control unit for providing control pressure functions;
a regulator valve communicating with said source and said electronic control unit and being operable to issue a regulated feed pressure; and
a ratio enable valve having a first position established by said electronic control unit for directing said regulated feed pressure to said control piston, and a second position established by a bias member for communicating fluid from said source at a reduced pressure to said control piston.

2. The hydraulic control system defined in claim 1 wherein the reduced pressure level in said second position of said ratio enable valve is established by a feed orifice and bleed orifice mechanism.

3. The hydraulic control system defined in claim 1 further wherein a pressure control valve means for limiting fluid pressure at said control piston to a maximum pressure value when said ratio enable valve is in said second position.

4. The hydraulic control system defined in claim 2 further wherein a pressure control valve means for limiting fluid pressure at said control piston to a maximum pressure value is disposed downstream of said bleed orifice.

5. The hydraulic control system defined in claim 2 further wherein a pressure control valve means for limiting fluid pressure at said control piston to a maximum pressure value is disposed in fluid communication between said feed orifice and said bleed orifice and is operative in said hydraulic control system only when said enable valve is in said second position.
